(19) United States
(12) Patent Application Publication
(10) Pub. No.: US 2018/0350086 A1
(43) Pub. Date: Dec. 6, 2018

(54) System And Method Of Dynamically Filtering Depth Estimates To Generate A Volumetric Map Of A Three-Dimensional Environment Having An Adjustable Maximum Depth

(71) Applicant: QUALCOMM Incorporated, San Diego, CA (US)

(72) Inventors: Charles Wheeler SWEET, III, San Diego, CA (US); Casimir WIERZYNSKI, La Jolla, CA (US)

(21) Appl. No.: 15/676,245

(22) Filed: Aug. 14, 2017

Related U.S. Application Data
(60) Provisional application No. 62/513,098, filed on May 31, 2017.

(51) Int. Cl. G06T 7/593; H04N 13/02; G06T 15/08; G06T 7/73; G06T 17/05

(52) U.S. Cl. CPC G06T 7/593; H04N 13/0271; G06T 15/08; G06T 7/73; B64C 39/024; G06T 2215/16; G06T 2207/30241; G06T 2207/10032; G06T 2207/10028; G06T 17/05

(57) ABSTRACT

Various systems and methods of dynamically filtering depth estimates to generate a volumetric map of a three-dimensional (3-D) environment having an adjustable maximum depth include obtaining sensor output including depth estimates and pose estimates in a robotic vehicle, detecting a condition that corresponds to an error level in the pose estimates, filtering the depth estimates obtained from the sensor output based on the detected condition, and generating the volumetric map of the 3-D environment using the filtered depth estimates. Filtering depth estimates obtained from the sensor output based on the detected condition may include adjusting a maximum depth parameter for generating the volumetric map. Further embodiments include a robotic vehicle and/or a computing device within a robotic vehicle including a processor configured with processor-executable instructions for controlling the maximum depth of a volumetric map of a 3-D environment.

### RELATED APPLICATION(S)

This application claims the benefit of priority to U.S. Provisional Patent Application No. 62/513,098, filed on May 31, 2017, entitled “System And Method Of Dynamically Filtering Voxel Data To Generate A Volumetric Map Of A Three-Dimensional Environment Having An Adjustable Maximum Depth,” the entire contents of which are incorporated herein by reference.

### BACKGROUND

Autonomous and semi-autonomous robotic vehicles, such as cars and unmanned aerial vehicles (UAVs), are typically configured with sensors (e.g., stereoscopic cameras, infrared sensors, etc.) that are capable of perceiving objects and determining their relative location (particularly distance) within a three-dimensional (3-D) environment. Data from such sensors may be used to generate a volumetric map of the environment for use in avoiding obstacles, path planning, and/or localization.

A volumetric map may represent objects detected at various distances up to a maximum distance or depth of the sensor's field of view. The maximum depth at which accurate distance measurements can be determined by a sensor is generally a fixed distance relative to the sensor that depends on the capabilities and/or accuracy of the sensor in use. A volumetric map may be implemented as a 3-D grid, such as a Cartesian, rectilinear, curvilinear or other structured or unstructured grid. When perceiving an object, depth sensors may produce collections of measurements sometimes called point clouds, which may be represented in the grid as collections of voxels. A voxel corresponds to a volumetric cell at a defined grid location in 3-D space. The value assigned to a voxel may be an integral value that represents the number of times that the object feature was detected at that grid location.

As a robotic vehicle navigates through the environment, however, the robotic vehicle may perform various maneuvers or encounter other conditions producing errors in an output of a localization system, a computerized system that performs a localization operation in order to determine a location or pose estimate (e.g., an orientation and/or position) of the robotic vehicle's perception system within a 3-D space based on the depth sensor output, or a computerized system that performs at least a localization operation in order to determine an orientation and/or position of the robotic vehicle's perception system (e.g., depth sensor) within 3-D space. As a result of such errors in localization system output (e.g., pose estimates of the robotic vehicle), inaccurate representations of 3-D objects in the volumetric map may occur.

### BRIEF DESCRIPTION OF THE DRAWINGS

The accompanying drawings, which are incorporated herein and constitute part of this specification, illustrate exemplary embodiments, and together with the general description given above and the detailed description given below, serve to explain the features of the various embodiments.

FIGS. 1A and 1B illustrate the concept of dynamically controlling the maximum depth for a volumetric map of a 3-D environment according to some embodiments.

FIGS. 2A and 2B illustrate front elevation and plan views, respectively, of a UAV equipped with a depth sensor suitable for use in some embodiments.

FIG. 3 illustrates components of a control unit of a UAV suitable for use in some embodiments.

FIG. 4 illustrates a method of dynamically controlling the maximum depth of a volumetric map of a 3-D environment according to some embodiments.

FIG. 5 illustrates a method of dynamically controlling the maximum depth of a volumetric map of a 3-D environment according to some embodiments.

FIG. 6 is a diagram that illustrates a method of filtering depth estimates obtained from the sensor output and/or adjusting a maximum depth parameter for generating the volumetric map based on the detected rate of rotation according to some embodiments.

FIG. 7 illustrates a method of dynamically controlling the maximum depth of a volumetric map of a 3-D environment according to some embodiments.

FIG. 8 illustrates a method of dynamically controlling the maximum depth of a volumetric map of a 3-D environment according to some embodiments.

FIG. 9 illustrates a method of dynamically controlling the maximum depth of a volumetric map of a 3-D environment according to some embodiments.

FIG. 10 is a component block diagram illustrating a processing device suitable for implementing various embodiments.

### SUMMARY

Various embodiments include methods that for generating a volumetric map of a 3-D environment based on dynamically filtered depth estimates including dynamically controlling the maximum depth of a volumetric map of a 3-D environment generated from the output of a robotic vehicle's depth sensor.

Various embodiments may include obtaining sensor output including depth estimates and pose estimates in a robotic vehicle (e.g., a UAV) equipped with a sensor capable of determining the distance to objects in the environment (referred to herein as a depth sensor), detecting a condition that corresponds to an error level in the pose estimates, filtering the depth estimates obtained from the sensor output based on the detected condition, and generating the volumetric map of the 3-D environment using the filtered depth estimates. In some embodiments, filtering the depth estimates obtained from the sensor output may include adjusting a maximum depth parameter for generating the volumetric map.

In some embodiments, detecting the condition that corresponds to the error level in the pose estimates may include detecting a rate of rotation of the robotic vehicle, and filtering the depth estimates obtained from the sensor output based on the detected condition may include filtering the depth estimates obtained from the sensor output based on the detected rate of rotation. In some embodiments, filtering the depth estimates obtained from the sensor output based on the detected rate of rotation may include determining whether the detected rate of rotation of the robotic vehicle exceeds a threshold and filtering the depth estimates obtained from the sensor output to reduce the maximum depth of the volumetric map in response to determining that the detected rate of rotation of the robotic vehicle exceeds the threshold. In some embodiments, filtering the depth estimates obtained from the sensor output based on the detected rate of rotation may further include filtering the depth estimates obtained from the sensor output to maintain or increase the maximum depth of the volumetric map in response to determining that the detected rate of rotation of the robotic vehicle does not exceed the threshold.

In some embodiments, detecting the condition that corresponds to the error level in the pose estimates may include detecting a noise level in the pose estimates, and filtering the depth estimates obtained from the sensor output based on the detected condition may include filtering the depth estimates obtained from the sensor output based on the detected noise level in the pose estimates.

In some embodiments, detecting the condition that corresponds to the error level in the pose estimates may include detecting a number of object features in the sensor output from the depth sensor, and filtering the depth estimates obtained from the sensor output based on the detected condition may include filtering the depth estimates obtained from the sensor output based on the number of object features detected in the sensor output.

In some embodiments, filtering the depth estimates obtained from the sensor output based on the detected condition may include discarding depth estimates associated with depths beyond a maximum depth parameter adjusted based on the detected condition. In some embodiments, filtering the depth estimates obtained from the sensor output based on the detected condition may include assigning a reduced confidence score to depth estimates associated with depths beyond a maximum depth parameter adjusted based on the detected condition.

In some embodiments, filtering the depth estimates obtained from the sensor output based on the detected condition may include generating depth estimates based on disparity data determined from the sensor output of a stereoscopic sensor, such that the determined disparity data fall within a range of disparities selected based on the detected condition.

In some embodiments, filtering the depth estimates obtained from the sensor output based on the detected condition may include generating depth estimates based on time delay data determined from the sensor output of a time-of-flight sensor, such that the determined time delay data fall within a range of time delays selected based on the detected condition. In some embodiments, filtering the depth estimates obtained from the sensor output based on the detected condition may include limiting a number of depth levels computed in a stereoscopic depth measurement.

Some embodiments may further include controlling a transmit power of the depth sensor in response to filtering the depth estimates obtained from the sensor output.

Further embodiments include a robotic vehicle and/or a computing device within a robotic vehicle including a processor that is coupled to a depth sensor and configured with processor-executable instructions to perform operations of any of the methods summarized above. In some embodiments, the depth sensor may be a camera, a stereoscopic camera, an image sensor, a radar sensor, a time-of-flight sensor, a sonar sensor, an ultrasound sensor, an active depth sensor, a passive depth sensor, or any combination thereof. In some embodiments, the robotic vehicle may be an unmanned aerial vehicle, a terrestrial vehicle, a space-based vehicle, or an aquatic vehicle. Further embodiments include a processing device (e.g., a system-on-chip (SoC)) including a processor configured with processor-executable instructions to perform operations of any of the methods summarized above. Further embodiments include a robotic vehicle and/or a computing device within a robotic vehicle including means for performing functions of any of the methods summarized above.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

As used herein, the term “depth sensor” refers to a sensor capable of determining the distance from the depth sensor to objects in the environment. Examples of depth sensors include, but are not limited to stereoscopic cameras, stereoscopic infrared sensors, trinocular cameras, lidar, time-of-flight sensors, structured light sensors, and systems combining cameras and distance sensors (e.g., radar, sonar, etc.). Similarly, the word “depth” is used herein to refer to a relative distance from a depth sensor to an object, and is not related to a depth of water.

As used herein, the terms “robotic vehicle” and “drone” refer to one of various types of vehicles including an onboard computing device configured to provide some autonomous or semi-autonomous capabilities. Examples of robotic vehicles include but are not limited to: aerial vehicles, such as an unmanned aerial vehicle (UAV); ground vehicles (e.g., an autonomous or semi-autonomous car, a vacuum robot, etc.); water-based vehicles (i.e., vehicles configured for operation on the surface of the water or under water); space-based vehicles (e.g., a spacecraft or space probe); and/or some combination thereof. In some embodiments, the robotic vehicle may be manned. In other embodiments, the robotic vehicle may be unmanned. In embodiments in which the robotic vehicle is autonomous, the robotic vehicle may include an onboard computing device configured to maneuver and/or navigate the robotic vehicle without remote operating instructions (i.e., autonomously), such as from a human operator (e.g., via a remote computing device). In embodiments in which the robotic vehicle is semi-autonomous, the robotic vehicle may include an onboard computing device configured to receive some information or instructions, such as from a human operator (e.g., via a remote computing device), and autonomously maneuver and/or navigate the robotic vehicle consistent with the received information or instructions. In some implementations, the robotic vehicle may be an aerial vehicle (unmanned or manned), which may be a rotorcraft or winged aircraft. For example, a rotorcraft (also referred to as a multirotor or multicopter) may include a plurality of propulsion units (e.g., rotors/propellers) that provide propulsion and/or lifting forces for the robotic vehicle. Specific non-limiting examples of rotorcraft include tricopters (three rotors), quadcopters (four rotors), hexacopters (six rotors), and octocopters (eight rotors). However, a rotorcraft may include any number of rotors.

The term “computing device” is used herein to refer to an electronic device equipped with at least a processor. Examples of computing devices may include UAV flight control and/or mission management computer that are onboard the UAV, as well as remote computing devices communicating with the UAV configured to perform operations of the various embodiments. Remote computing devices may include wireless communication devices (e.g., cellular telephones, wearable devices, smart-phones, web-pads, tablet computers, Internet enabled cellular telephones, Wi-Fi® enabled electronic devices, personal data assistants (PDA's), laptop computers, etc.), personal computers, and servers. In various embodiments, computing devices may be configured with memory and/or storage as well as wireless communication capabilities, such as network transceiver(s) and antenna(s) configured to establish a wide area network (WAN) connection (e.g., a cellular network connection, etc.) and/or a local area network (LAN) connection (e.g., a wireless connection to the Internet via a Wi-Fi® router, etc.).

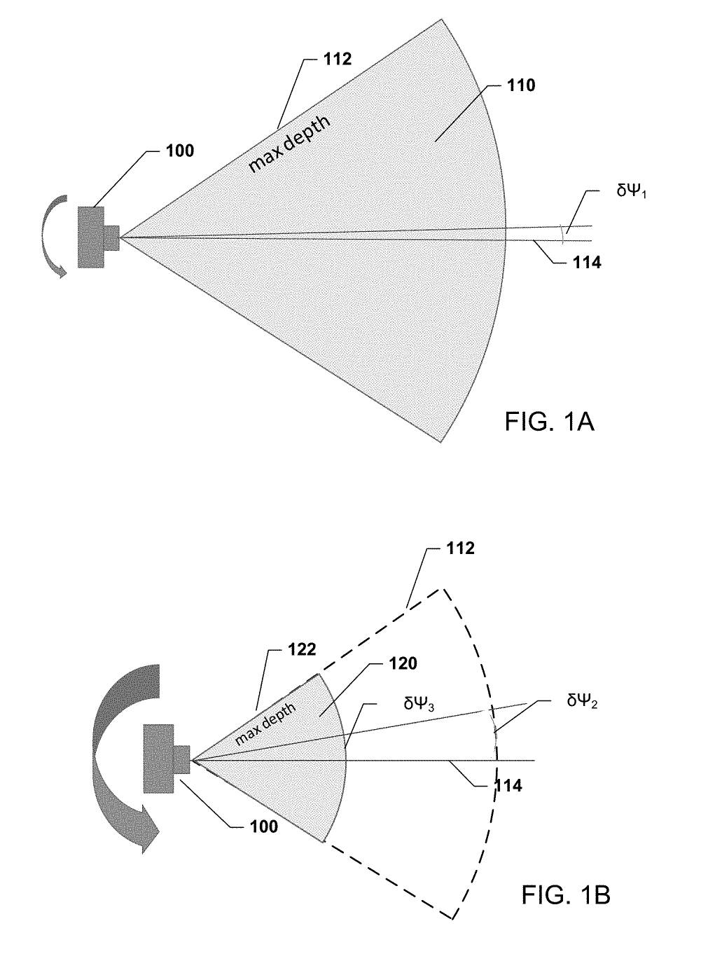

Various embodiments include methods for dynamically filtering depth estimates to generate a volumetric map of a 3-D environment having an adjustable maximum depth. In some embodiments, generating a volumetric map of a 3-D environment based on dynamically filtered depth estimates may include dynamically controlling the maximum depth of a volumetric map of a 3-D environment generated from the output of a robotic vehicle's depth sensor. For example, FIGS. 1A and 1B illustrate the concept of dynamically controlling the maximum depth for a volumetric map of a 3-D environment according to some embodiments. A depth sensor 100 may be configured to output data as the robotic vehicle navigates through an environment. The depth sensor output data may be used to generate point clouds of depth estimates representative of objects detected at various depths within the sensor's field of view 110 up to a maximum depth 112. The maximum depth 112 of a volumetric map is generally a fixed distance associated with the capabilities and/or accuracy of the depth sensor 100 in use. As the robotic vehicle moves, point clouds of depth estimates generated from different vantage points may be integrated or otherwise combined to form a volumetric map of the 3-D environment.

In response to some vehicular movements, however, error may be introduced in an output of a localization system, which may be a computerized system that performs a localization operation in order to determine pose estimates (e.g., an orientation and/or position) of the robotic vehicle's perception system within a 3-D space based, in part, on the depth sensor output. Errors in the localization system output (e.g., pose estimates of the robotic vehicle) may cause false detections and/or location errors of objects that increase with the relative distance to or depth of such objects in the generated map. For example, as shown in FIG. 1A, relatively slow rotations of the robotic vehicle (e.g., pitch, yaw, or roll) may cause minimal location error (δΨ₁) for objects detected along a line of sight 114. However, as shown in FIG. 1B, relatively fast rotations of the robotic vehicle may introduce error in the pose estimates of the robotic vehicle that causes greater location error of objects. For example, significant location errors (e.g., δΨ₂) in the location of objects within a volumetric map may result at distances near the maximum depth 112 capability of the depth sensor 100.

To address this problem, in some embodiments, volumetric maps may be generated with an adjustable maximum depth 122 that depends on a robotic vehicle's rate of rotation. For example, in some embodiments, the maximum depth 122 of the volumetric map may be reduced in response to increases in the robotic vehicle's rate of rotation. In some embodiments, the maximum depth 122 of the volumetric map may be maintained or other increased towards the depth sensor's maximum depth 112 capability in response to the robotic vehicle rotating slowly or not at all (e.g., hovering or otherwise stationary).

FIG. 1B illustrates an embodiment in which the maximum depth of a volumetric map is controlled or adjusted, or the sensor data used to generate the volumetric map may be filtered, based on the robotic vehicle's rate of rotation. However, in some embodiments, the maximum depth of a volumetric map may be adjusted based on other conditions or measurable parameters that correspond directly or indirectly to an error level in the output of the robotic vehicle's localization system (e.g., pose estimates). Other conditions may include localization noise level and the extent of detectable object features in the depth sensor output. For example, greater noise level and/or the lack of detectable object features in the depth sensor's output may increase the probability of significant location error in volumetric maps generated from such output.

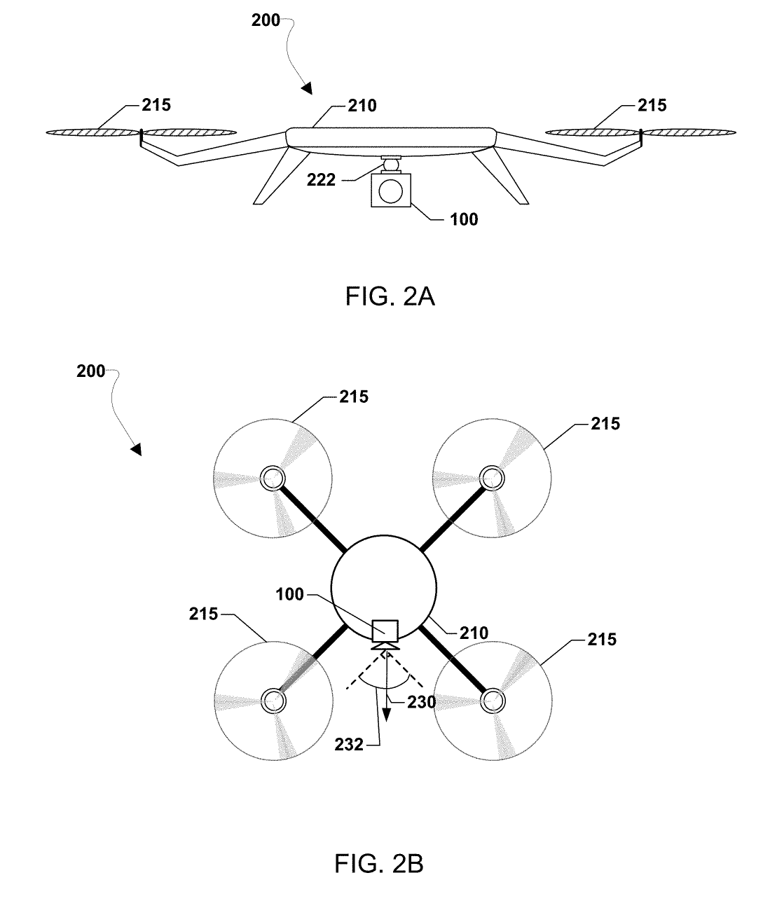

FIGS. 2A and 2B illustrate front elevation and plan views, respectively, of an unmanned aerial vehicle (UAV) 200 equipped with a depth sensor 100 suitable for use in some embodiments. With reference to FIGS. 1A and 1B, in some embodiments, the depth sensor 100 may be any type of sensor that is capable of perceiving and locating objects in an environment within a limited field of view. For example, the depth sensor 100 may include a camera system (e.g., a stereoscopic camera), image sensor, radar sensor, lidar, time-of-flight sensor, sonar sensor, ultrasound sensor, an active depth sensor, a passive depth sensor, or any combination thereof. The depth sensor 100 may be attached to a gimbal 222 that is attached to a main housing or frame 210 of the UAV 200. In some embodiments, the depth sensor 100 and the gimbal 222 may be integrated into the main housing 210 of the UAV 200, such that the depth sensor 100 is exposed through an opening in the main housing 210.

Different types of sensors (i.e., sensors using different technologies) typically have different fields of view in terms of viewing angle and range sensitivities or maximum depth detection capabilities. For example, the depth sensor 100 may be characterized by the direction 230 in which the depth sensor faces and/or the sensor's field of view 232. The sensor's direction 230 may be a centerline of the sensor's field of view 232. Some sensors may have a narrow field of view 232, such as laser radars (known as “lidar”), in which case the characteristic evaluated in the various embodiments may be only the direction 230. Some view sensors may have a wide field of view 232, such as cameras equipped with a fish eye lens, and radars with near-omnidirectional antennas.

The UAV 200 may include an onboard computing device within the main housing 210 that is configured to fly and/or operate the UAV 200 without remote operating instructions (i.e., autonomously), and/or with some remote operating instructions or updates to instructions stored in a memory, such as from a human operator or remote computing device (i.e., semi-autonomously).

The UAV 200 may be propelled for flight in any of a number of known ways. For example, two or more propulsion units, each including one or more rotors 215, may provide propulsion or lifting forces for the UAV 200 and any payload carried by the UAV 200. Although the UAV 200 is illustrated as a quad copter with four rotors, a UAV 200 may include more or fewer than four rotors 215. In some embodiments, the UAV 200 may include wheels, tank-treads, or other non-aerial movement mechanisms to enable movement on the ground, on or in water, and combinations thereof. The UAV 200 may be powered by one or more types of power source, such as electrical, chemical, electro-chemical, or other power reserve, which may power the propulsion units, the onboard computing device, and/or other onboard components. For ease of description and illustration, some detailed aspects of the UAV 200 are omitted, such as wiring, frame structure, power source, landing columns/gear, or other features that would be known to one of skill in the art.

Although the depth sensor 100 is illustrated as being attached to the UAV 200, the depth sensor 100 may, in some embodiments, be attached to other types of robotic vehicles, including both manned and unmanned robotic vehicles.

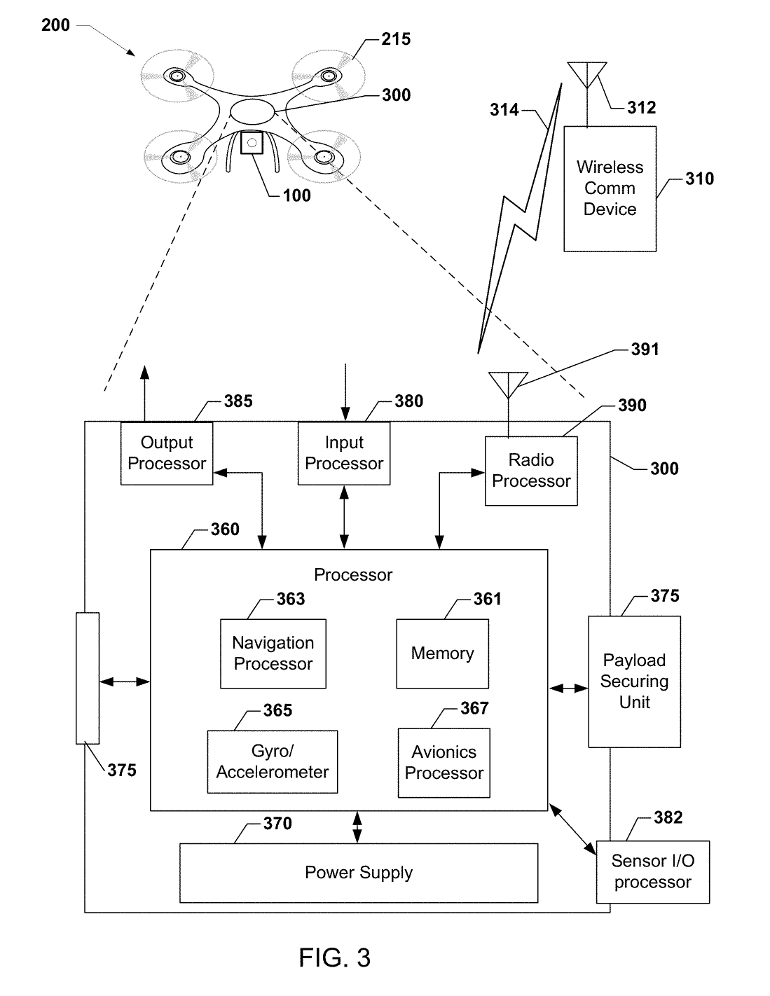

FIG. 3 illustrates components of a control unit 300 of a UAV 200 suitable for use in various embodiments. With reference to FIGS. 1A-3, the control unit 300 may be configured to implement methods of dynamically controlling the maximum depth of a volumetric map of a 3-D environment. The control unit 300 may include various circuits and devices used to power and control the operation of the UAV 200. The control unit 300 may include a processor 360, a power supply 370, payload-securing units 375, an input processor 380, a depth sensor input/output (I/O) processor 382, an output processor 385, and a radio processor 390. The depth sensor I/O processor 382 may be coupled to a camera or other depth sensor 100.

In some embodiments, the avionics processor 367 coupled to the processor 360 and/or the navigation unit 363 may be configured to provide travel control-related information such as altitude, attitude, airspeed, heading and similar information that the navigation processor 363 may use for navigation purposes, such as dead reckoning between GNSS position updates. The avionics processor 367 may include or receive data from the gyroscope/accelerometer 365 that provides data regarding the orientation and accelerations of the UAV 200 that may be used in navigation and positioning calculations.

In some embodiments, the processor 360 may be dedicated hardware specifically adapted to implement a method of dynamically controlling the maximum depth of a volumetric map of a 3-D environment according to some embodiments. In some embodiments, the processor 360 may be a programmable processing unit programmed with processor-executable instructions to perform operations of the various embodiments. The processor 360 may also control other operations of the UAV, such as navigation, collision avoidance, data processing of sensor output, etc. In some embodiments, the processor 360 may be a programmable microprocessor, microcomputer or multiple processor chip or chips that can be configured by software instructions to perform a variety of functions of the UAV. In some embodiments, the processor 360 may be a combination of dedicated hardware and a programmable processing unit.

In some embodiments, the processor 360 may be coupled to the depth sensor I/O processor 382 to receive images or data output from an onboard camera system or other depth sensor 100. In some embodiments, the processor 360 may be configured to process, manipulate, store, and/or retransmit the depth sensor output received via the depth sensor I/O processor 382 for a variety of applications, including but not limited to image/video recording, package delivery, collision avoidance, and path planning,

In some embodiments, the processor 360 may include or be coupled to memory 361, a navigation processor 363, a gyroscope/accelerometer 365, and/or an avionics processor 367. In some embodiments, the navigation processor 363 may include a global navigation satellite system (GNSS) receiver (e.g., one or more global positioning system (GPS) receivers) enabling the UAV 100 to navigate using GNSS signals. Alternatively or additionally, the navigation processor 363 may be equipped with radio navigation receivers for receiving navigation beacons or other signals from radio nodes, such as navigation beacons (e.g., very high frequency (VHF) omni directional range (VOR) beacons), Wi-Fi® access points, cellular network sites, radio station, remote computing devices, other UAVs, etc. In some embodiments, the processor 360 and/or the navigation processor 363 may be configured to communicate with a server or other wireless communication device 310 through a wireless connection (e.g., a cellular data network) to receive data useful in navigation, provide real-time position reports, and assess data.

In some embodiments, the processor 360 may receive data from the navigation processor 363 and use such data in order to determine the present position and orientation of the UAV 200, as well as an appropriate course towards a destination or intermediate sites. In some embodiments, the avionics processor 367 coupled to the processor 360 and/or the navigation unit 363 may be configured to provide travel control-related information such as altitude, attitude, airspeed, heading and similar information that the navigation processor 363 may use for navigation purposes, such as dead reckoning between GNSS position updates. In some embodiments, the avionics processor 367 may include or receive data from the gyroscope/accelerometer 365 that provides data regarding the orientation and accelerations of the UAV 200 that may be used in flight control calculations.

In some embodiments, the control unit 300 may be equipped with the input processor 380 and an output processor 385. For example, in some embodiments, the input processor 380 may receive commands or data from various external sources and route such commands or data to the processor 360 to configure and/or control one or more operations of the UAV 200. In some embodiments, the processor 360 may be coupled to the output processor 385 to output control signals for managing the motors that drive the rotors 215 and other components of the UAV 200. For example, the processor 360 may control the speed and/or direction of the individual motors of the rotors 215 to enable the UAV 200 to perform various rotational maneuvers, such as pitch, roll, and yaw.

In some embodiment, the radio processor 390 may be configured to receive navigation signals, such as signals from aviation navigation facilities, etc., and provide such signals to the processor 360 and/or the navigation processor 363 to assist in UAV navigation. In various embodiments, the navigation processor 363 may use signals received from recognizable radio frequency (RF) emitters (e.g., AM/FM radio stations, Wi-Fi® access points, and cellular network base stations) on the ground. The locations, unique identifiers, signal strengths, frequencies, and other characteristic information of such RF emitters may be stored in a database and used to determine position (e.g., via triangulation and/or trilateration) when RF signals are received by the radio processor 390. Such a database of RF emitters may be stored in the memory 361 of the UAV 200, in a ground-based server in communication with the processor 360 via a wireless communication link, or in a combination of the memory 361 and a ground-based server (not shown).

In some embodiment, the processor 360 may use the radio processor 390 to conduct wireless communications with a variety of wireless communication devices 310, such as a beacon, server, smartphone, tablet, or other computing device with which the UAV 100 may be in communication. A bi-directional wireless communication link (e.g., wireless signals 314) may be established between a transmit/receive antenna 391 of the radio processor 390 and a transmit/receive antenna 312 of the wireless communication device 310. In an example, the wireless communication device 310 may be a cellular network base station or cell tower. The radio processor 390 may be configured to support multiple connections with different wireless communication devices (e.g., wireless communication device 310) having different radio access technologies.

In some embodiments, the processor 360 may be coupled to one or more payload-securing units 375. The payload-securing units 375 may include an actuator motor that drives a gripping and release mechanism and related controls that are responsive to the control unit 300 to grip and release a payload package in response to commands from the control unit 300.

In some embodiments, the power supply 370 may include one or more batteries that may provide power to various components, including the processor 360, the payload-securing units 375, the input processor 380, the depth sensor I/O processor 382, the output processor 385, and the radio processor 390. In addition, the power supply 370 may include energy storage components, such as rechargeable batteries. In this way, the processor 360 may be configured with processor-executable instructions to control the charging of the power supply 370, such as by executing a charging control algorithm using a charge control circuit. Alternatively or additionally, the power supply 370 may be configured to manage its own charging.

While the various components of the control unit 300 are illustrated in FIG. 3 as separate components, some or all of the components (e.g., the processor 360, the output processor 385, the radio processor 390, and other units) may be integrated together in a single device or processor system, such as a system-on-chip.

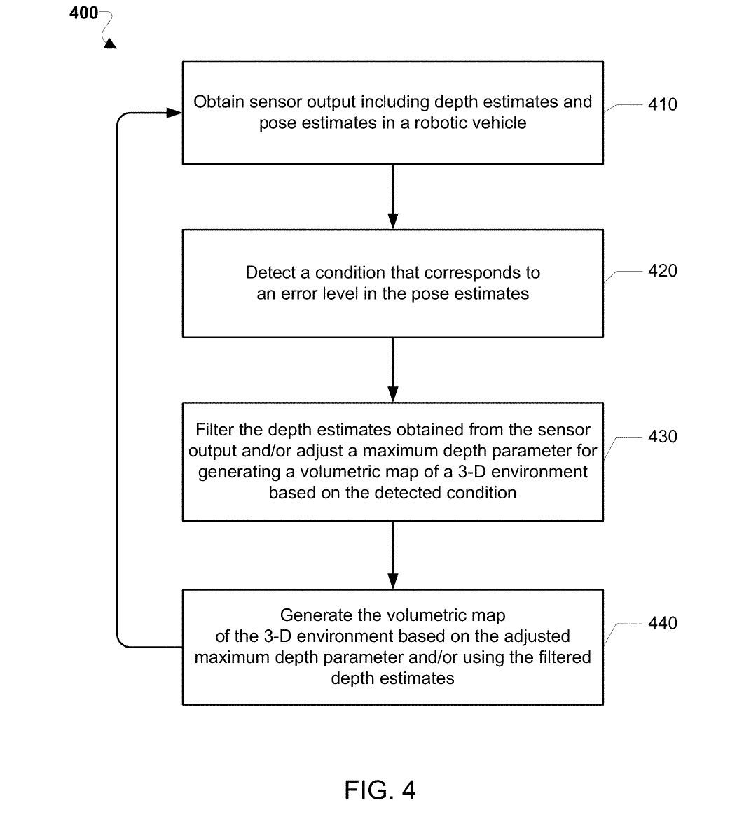

FIG. 4 illustrates a method 400 of dynamically controlling the maximum depth of a volumetric map of a 3-D environment generated from the output of a depth sensor according to some embodiments. With reference to FIGS. 1-4, operations of the method 400 may be performed by a processor (e.g., 360) of a control unit (e.g., 300) of a robotic vehicle (e.g., the UAV 200), a processor of a depth sensor (e.g., 100), or another processor (e.g., a processor dedicated to generating volumetric maps. For ease of reference, the term “processor” is used generally to refer to the processor or processors implementing operations of the method 400.

In block 410, the processor may obtain or receive sensor output from a localization system including depth estimates and pose estimates in a robotic vehicle. In some embodiments, the sensor output may be data capable of being processed to determine depth estimates of and/or directions to various object features detected within the depth sensor's field of view (e.g., 110, 120). For example, in some embodiments, the sensor output may be data received from a camera (e.g., a stereoscopic camera), image sensor, radar sensor, time-of-flight sensor, sonar sensor, ultrasound sensor, an active depth sensor, a passive depth sensor, or any combination thereof.

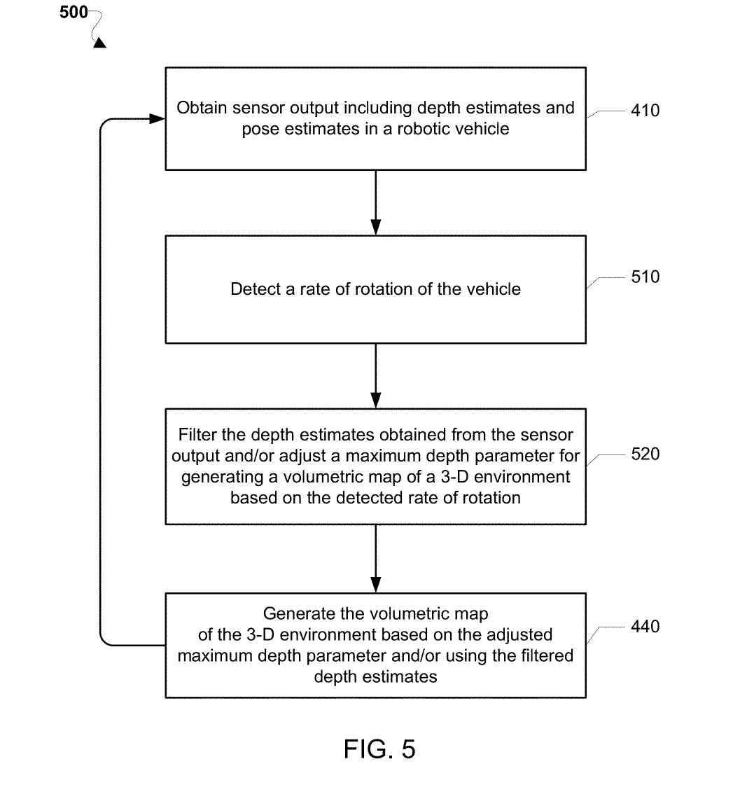

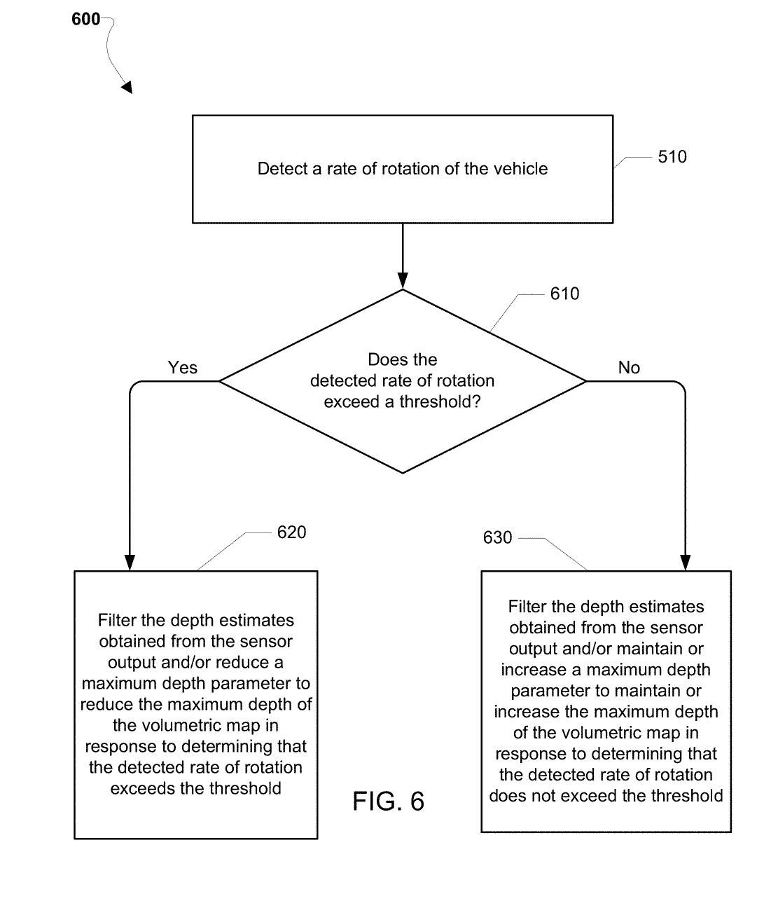

In block 420, the processor may detect a condition that corresponds to an error level in the pose estimates of the robotic vehicle and/or other output of the localization system. In some embodiments, the pose estimates output by the localization system may include a location (e.g., orientation and/or position) of the robotic vehicle's perception system within a 3-D space. In some embodiments, the detected condition may be a condition that is directly or indirectly related to an error level in the depth sensor output that causes errors in the pose estimates or other localization system output. For example, in some embodiments, a noise level or other characteristics of the depth sensor output may be directly related to an error level in sensor output. In some embodiments, when a robotic vehicle is rotating (e.g., yawing), the rate of rotation (e.g., angular velocity) may be indirectly related to an error level in depth sensor output. For example, as the angular velocity of the rotation exceeds a particular threshold, the output images from a stereoscopic camera may become blurry or skewed, resulting in inaccurate depth estimates to objects, particularly objects at greater distance from the depth sensor. If blurry or skewed stereoscopic images are used to generate the volumetric map, the 3-D positions of distant objects within the volumetric map may be inaccurate. An embodiment using a robotic vehicle's rate of rotation for detecting an error level sensor output is disclosed with reference to FIGS. 5 and 6. In some embodiments, other conditions that may directly or indirectly correspond to an error level in the pose estimates or other output of the localization system may be detected.

In block 430, the processor may filter the depth estimates obtained from the sensor output and/or adjust a maximum depth parameter for generating a volumetric map based on the detected condition (e.g., rate of rotation, noise level or number of object features detected in the sensor output, etc.). In some embodiments, filtering the depth estimates obtained from the sensor may include one or more of deleting from memory, ignoring, or not passing on from the sensor any depth estimate that is unreliable or has a larger error as determined by the processor based on the detected condition. In some embodiments, filtering depth estimates obtained from the sensor may include generating depth estimates based on disparity data determined from the sensor output of a stereoscopic sensor, such that the determined disparity data fall within a range of disparities selected based on the detected condition. In some embodiments, filtering depth estimates obtained from the sensor may include generating depth estimates based on time delay data determined from the sensor output of a time-of-flight sensor, such that the determined time delay data fall within a range of time delays selected based on the detected condition. In some embodiments, filtering depth estimates obtained from the sensor may include discarding depth estimates associated with depths beyond a maximum depth parameter adjusted based on the detected condition. In some embodiments, filtering the depth estimates obtained from the sensor output based on the detected condition may include limiting a number of depth levels computed in a stereoscopic depth measurement. For example, in some embodiments, a depth level may be indicative of, or correspond to, a specific disparity value or range of disparitive values determined from the sensor output of a stereoscopic sensor and from which depth estimates or measurements may be obtained, thereby reducing the amount of computation during depth map generation which may occur before voxel map generation.

In some embodiments, the maximum depth parameter may be an absolute depth value to use as the maximum depth of the volumetric map. In some embodiments, the maximum depth parameter may be an offset value used to calculate the maximum depth of the volumetric map. For example, in some embodiments, the maximum depth of the volumetric map may be calculated by adding or subtracting the offset value from a default or previously calculated maximum depth value.

In some embodiments, the maximum depth parameter may be adjusted and/or the depth estimates obtained from the sensor to generate the volumetric map may be filtered according to a predefined relationship between the maximum depth parameter and/or the depth estimate filtering and the detected condition. In some embodiments, the adjustable maximum depth parameter and/or the depth estimate filtering may have an inverse relationship with the detected condition. In some embodiments, the adjustable maximum depth parameter and/or the depth estimate filtering may have a direct relationship with the detected condition. In some embodiments, the maximum depth parameter and/or the depth estimate filtering may be adjusted in response to the detected condition exceeding one or more thresholds.

In block 440, the processor may generate the volumetric map of the 3-D environment from the depth sensor output based on the adjusted maximum depth parameter and/or using the filtered depth estimates. In some embodiments, the volumetric map may be generated as a 3-D grid, such as a Cartesian, rectilinear, curvilinear or other structured or unstructured grid. When perceiving an object, the depth sensor 100 may produce collections of depth estimates sometimes called point clouds, which may be represented in the grid as collections of voxels. A voxel corresponds to a volumetric cell at a defined grid location in 3-D space. The value assigned to a voxel may be an integral value that represents the number of times that the object feature was detected at that grid location.

In some embodiments, to generate the volumetric map having an adjusted maximum depth, the adjusted maximum depth parameter may be used to identify voxel candidates for filtering (e.g., elimination) that are likely to contain erroneous information. For example, in some embodiments, the processor may filter voxel data by removing voxels from the volumetric map that are associated with depths that exceed the adjusted maximum depth parameter. For example, where the maximum depth parameter is reduced, voxels associated with object features detected within an effectively smaller field of view (e.g., 120) may remain in the volumetric map while all other voxels are filtered out, removed or never generated. In some embodiments, a voxel may be effectively filtered out, removed or not generated by setting its value to zero or another null value. In some embodiments, voxels that are associated with depths that exceed the adjusted maximum depth parameter may be assigned a reduced confidence score. Although the voxels may not be removed from the generated volumetric map, the reduced confidence scores may be used to flag these voxels as having an increased probability of containing erroneous or unreliable object information.

FIG. 5 illustrates a method 500 of dynamically controlling the maximum depth of a volumetric map of a 3-D environment according to some embodiments. With reference to FIGS. 1-5, operations of the method 500 may be performed by a processor (e.g., 360) of a control unit (e.g., 300) of a robotic vehicle (e.g., the UAV 200), a processor of a depth sensor (e.g., 100), or another processor (e.g., a processor dedicated to generating volumetric maps. For ease of reference, the term “processor” is used generally to refer to the processor or processors implementing operations of the method 500.

In blocks 410 and 440, the processor may perform operations of like numbered blocks of the method 400 as described.

In block 510, the processor (e.g., the processor 360 in the control unit 300) may detect a rate of rotation of the robotic vehicle (e.g., the UAV 200). For example, in some embodiments, the processor may obtain information indicating that the robotic vehicle is rotating at a particular rate. For example, the processor may receive information indicating that the robotic vehicle is pitching, yawing, and/or rolling at a particular rate of rotation. The rate of rotation may include an angular velocity specified in terms of radians per unit time, degrees per unit time, or the number of rotations per unit time, for example. In some embodiments, such information or knowledge may be obtained from a navigation processor (e.g., 363 in the control unit 300), gyro/accelerometers (e.g., 365), an avionics processor (e.g., 367), and/or a combination thereof.

In block 520, the processor (e.g., 360) may filter depth estimates obtained from the sensor output and/or adjust a maximum depth parameter for generating a volumetric map of a 3-D environment based on the detected rate of rotation. In some embodiments, filtering depth estimates obtained from the sensor output may include one or more of deleting from memory, ignoring, or not passing on from the sensor depth estimates that are unreliable or have larger errors as determined by the processor based on the detected rate of rotation. In some embodiments, the maximum depth parameter may be adjusted according to a predefined relationship between the maximum depth parameter and the detected rate of rotation. For example, when a robotic vehicle is rotating (e.g., yawing), the rate of rotation (e.g., angular velocity) may be indirectly related to an error level in the pose estimates or other output of the localization system. In particular, as the angular velocity of the rotation exceeds a particular threshold, the output images from a stereoscopic camera may become blurry or skewed, causing errors in the pose estimates or other localization system output which may propagate into inaccurate object depth estimates used to generate the volumetric map. Conversely, when the robotic vehicle is rotating slowly or not at all (e.g., UAV 200 hovering), the probability of errors in sensor output and thus localization system output (e.g., pose estimates of the robotic vehicle) may be minimal, if any. Thus, in some embodiments, the maximum depth parameter may be calculated to be inversely related to the robotic vehicle's rate of rotation. For example, as the rate of rotation increases, the maximum depth parameter may be reduced according to a predetermined inverse relationship (e.g., inversely proportional, exponential, etc.). In some embodiments, the maximum depth parameter may be continuously adjusted to coincide with any changes in the robotic vehicle's rate of rotation. In some embodiments, the maximum depth parameter may be adjusted in response to the detected condition exceeding or falling below one or more thresholds.

FIG. 6 is a diagram that illustrates a method 600 of filtering depth estimates obtained from the sensor output and/or adjusting a maximum depth parameter for generating the volumetric map based on the detected rate of rotation according to some embodiments. With reference to FIGS. 1-6, operations of the method 600 may be performed by a processor (e.g., 360) of a control unit (e.g., 300) of a robotic vehicle (e.g., the UAV 200), a processor of a depth sensor (e.g., 100), or another processor (e.g., a processor dedicated to generating volumetric maps. For ease of reference, the term “processor” is used generally to refer to the processor or processors implementing operations of the method 600.

In block 510, the processor may perform operations of the like numbered block of the method 500 as described.

In determination block 610, the processor may determine whether the detected rate of rotation exceeds a threshold. For example, in some embodiments, the processor may compare the detected angular velocity of the robotic vehicle performing a rotational maneuver (e.g., pitch, roll, or yaw) to one or more thresholds. The threshold rate of rotation may be the same or different for each type of rotational maneuver. In some embodiments, the detected rate of rotation may be compared to multiple threshold rotation rates, such that each threshold is associated with different error levels in pose estimates or other output of the localization system. Depending on whether the detected rate of rotation exceeds or does not exceed a threshold, the processor may determine whether to reduce, increase or maintain the maximum depth parameter used to generate the volumetric map of the 3-D environment as perceived by the depth sensor 100.

For example, in response to determining that the detected rate of rotation exceeds the threshold (i.e., determination block 610=“Yes”), the processor may filter depth estimates obtained from the sensor output and/or reduce the maximum depth parameter to reduce the maximum depth of the volumetric map in block 620. In some embodiments, the processor may filter the depth estimates obtained from the sensor output and/or reduce the maximum depth parameter by a preconfigured amount associated with the particular threshold. In some embodiments, the maximum depth parameter may be reduced according to a predefined inverse relationship between the maximum depth parameter and the detected rate of rotation. Thus, the threshold may trigger a reduction in the maximum depth parameter, such that the actual reduction is determined to coincide with the detected rate of rotation.

In response to determining that the detected rate of rotation does not exceed the threshold, the processor may filter depth estimates obtained from the sensor output and/or maintain or increase the maximum depth parameter to maintain or increase the maximum depth of the volumetric map in block 630. For example, in some embodiments, if the maximum depth parameter is currently set at the sensor's maximum depth 112 detection capability, the processor may continue to maintain the current maximum depth parameter in response to determining that the threshold is not exceeded (i.e., the robotic vehicle is rotating slowly or not at all). In some embodiments, if the maximum depth parameter is currently set for a maximum depth that is less than the sensor's maximum depth detection capability, the processor may increase the maximum depth parameter. In some embodiments, the processor may increase the maximum depth parameter to coincide with the sensor's maximum depth detection capability or some intermediate incremental value.

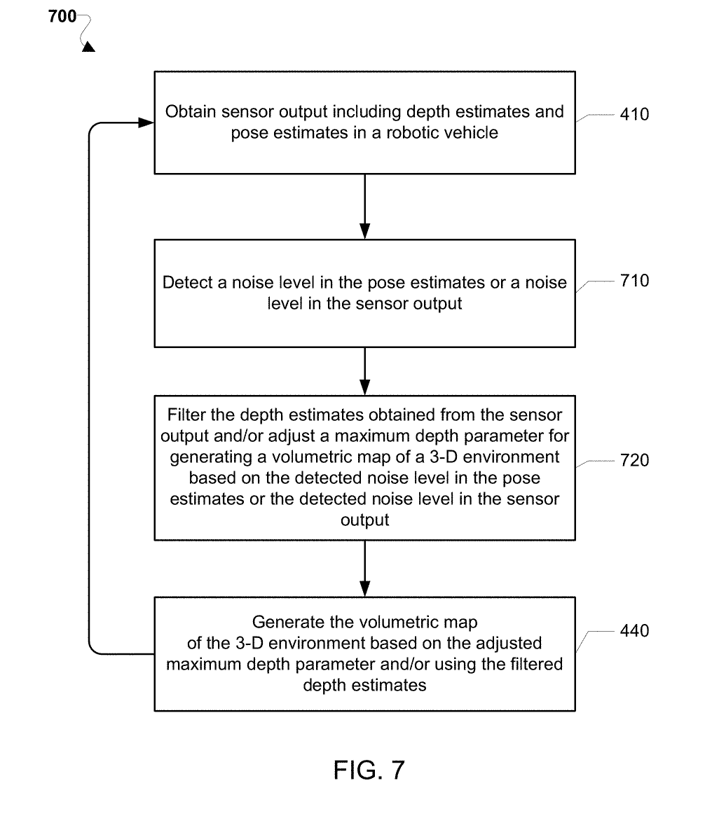

FIG. 7 illustrates a method 700 of dynamically controlling the maximum depth of a volumetric map of a 3-D environment according to some embodiments. With reference to FIGS. 1-7, operations of the method 700 may be performed by a processor (e.g., 360) of a control unit (e.g., 300) of a robotic vehicle (e.g., the UAV 200), a processor of a depth sensor (e.g., 100), or another processor (e.g., a processor dedicated to generating volumetric maps. For ease of reference, the term “processor” is used generally to refer to the processor or processors implementing operations of the method 700.

In blocks 410 and 440, the processor may perform operations of like numbered blocks of the method 400 as described.

In block 710, the processor may detect a noise level in pose estimates and/or other output of the localization system or a noise level in the depth sensor output from the depth sensor. For example, in some embodiments, depth estimates may be generated using the output of the localization system that locates the robotic vehicle perception system in 3-D space at the time the sensor output (e.g., depth measurement) was obtained. Thus, when the output of the localization system is noisy (e.g., highly variable), the resulting voxel representation of a volumetric map may include significant errors in the perceived locations of objects and particularly at distances remote from the robotic vehicle's depth sensor. Therefore, in order to compensate for such locational errors, the processor may remove depth estimates from the generated map at distances beyond an adjustable maximum depth based on the detected noise level in the localization system output, e.g., in block 720.

In some embodiments, the processor may detect a noise level in the depth sensor output from the depth sensor using any known techniques. For example, in image processing, the processor may determine the noise level in the output images, including but not limited to Gaussian noise, fat-tail distributed or impulsive noise, shot noise, quantization noise, film grain, anisotropic noise, and noise from sources of electromechanical interference for example. In some embodiments, the processor may determine noise levels directly from an analysis of the depth sensor output. As previously discussed, depth estimates may be generated using the output of the localization system that locates the robotic vehicle perception system in 3-D space at the time the sensor output (e.g., depth measurement). Thus, noise in the sensor output of a depth sensor may affect the pose estimates or other output of the localization system, which may propagate into inaccurate object depth estimates used to generate the volumetric map. Therefore, in order to compensate for such locational errors, the processor may remove depth estimates from the generated map at distances beyond an adjustable maximum depth based on the detected noise level in the depth sensor output, e.g. in block 720.

In block 720, the processor may filter depth estimates obtained from the sensor output and/or adjust a maximum depth parameter for generating a volumetric map of a 3-D environment based on the detected noise level in the pose estimates or other output of the localization system and/or the detected noise level in the depth sensor output. For example, in some embodiments, depth estimates may be filtered and/or the maximum depth parameter may be adjusted according to a predefined relationship that is a function of the detected noise level in the pose estimates or other output of the localization system and/or the detected noise level in the depth sensor output. For example, as the noise level detected in the localization system output (e.g., pose estimates) and/or the depth sensor output increases, the processor's ability to accurately determine the depths of objects sensed within the environment degrades, thereby introducing false detection and/or location error of objects in the generated map. Conversely, when less noise is detected in the localization system output and/or the depth sensor output, the processor's ability to generate accurate 3-D representations in greatly improved. Thus, in some embodiments, the maximum depth parameter may be calculated to be inversely related to the noise level detected in sensor output. For example, as the detected noise level increases, the maximum depth parameter may be reduced according to a predetermined inverse relationship (e.g., inversely proportional, exponential, etc.). Conversely, as the noise level decreases or falls below a set threshold, the maximum depth parameter may be maintained or increased up to the sensor's default maximum depth capability. In some embodiments, the maximum depth parameter may be continuously adjusted to coincide with any changes in the detected noise level. In some embodiments, the maximum depth parameter may be adjusted in response to the detected noise level exceeding or falling below one or more thresholds.

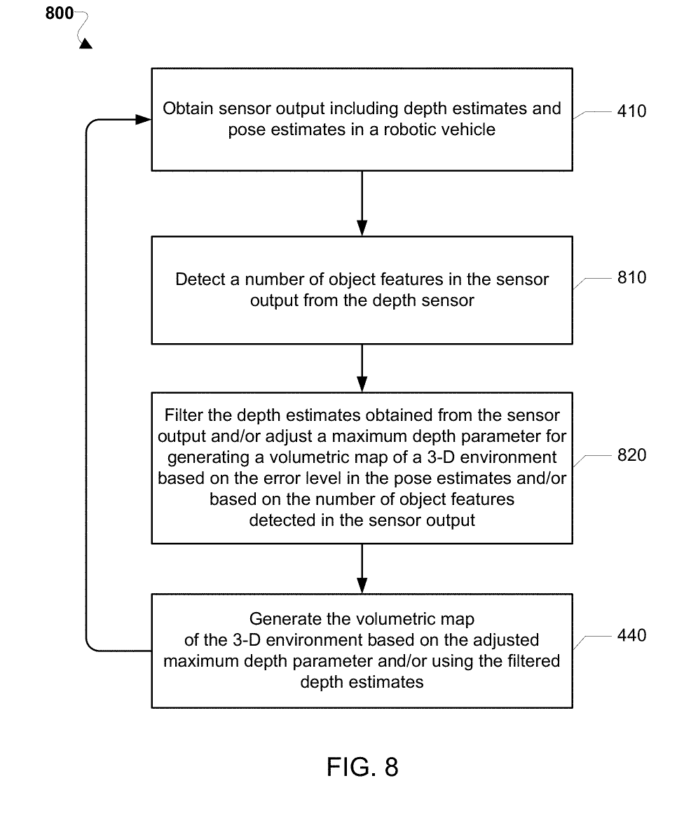

FIG. 8 illustrates a method 800 of dynamically controlling the maximum depth of a volumetric map of a 3-D environment according to some embodiments. With reference to FIGS. 1-8, operations of the method 800 may be performed by a processor (e.g., 360) of a control unit (e.g., 300) of a robotic vehicle (e.g., the UAV 200), a processor of a depth sensor (e.g., 100), or another processor (e.g., a processor dedicated to generating volumetric maps. For ease of reference, the term “processor” is used generally to refer to the processor or processors implementing operations of the method 800.

In blocks 410 and 440, the processor may perform operations of like numbered blocks of the method 400 as described.

In block 810, the processor may detect a number of object features in the depth sensor output from the depth sensor. For example, in some embodiments, the processor's ability to generate accurate volumetric maps of a 3-D environment may depth on the number or amount of detectable object features in the depth sensor output. Thus, sensor output lacking a sufficient number of detectable object features (e.g., sensor output corresponding to aerial or surface views lacking distinctive features) may result in the processor having insufficient depth information to accurately construct a volumetric map of the 3-D environment, particularly at depths distant from the sensor. In some embodiments, detecting the number of object features in the depth sensor output may include determining the number of edges, polygons, or other distinctive features in the depth sensor output that provide an indication of depth.

In block 820, the processor (e.g., 360) may filter depth estimates obtained from the sensor output and/or adjust a maximum depth parameter for generating a volumetric map of a 3-D environment based on the error level in the localization system output (e.g., pose estimates) and/or based on the number of object features detected in the depth sensor output. For example, in some embodiments, depth estimate filtering and/or the maximum depth parameter may be adjusted according to a predefined relationship that is a function of the number of object features detected in the depth sensor output. For example, as the number of object features detected in the depth sensor output falls below a certain threshold, the processor's ability to accurately determine the depth information within the environment degrades, thereby introducing false detection and/or location error of objects in the generated map. Conversely, when the number of object features detected in the depth sensor output increases to a sufficient number, the processor's ability to generate accurate 3-D representations in greatly improved. Thus, in some embodiments, the maximum depth parameter may be calculated to be directly related to the number of object features detected in sensor output, including but not limited to edges, polygons, and/or other distinctive features from which depth estimates may be determined. For example, as the detected number of object features falls below a threshold number, the maximum depth parameter may be reduced according to a predetermined inverse relationship (e.g., inversely proportional, exponential, etc.). Conversely, as the number of object features detected in the depth sensor output increases above the threshold number, the maximum depth parameter may be maintained or increased up to the sensor's default maximum depth capability. In some embodiments, the maximum depth parameter may be continuously adjusted to coincide with any changes in the number of object features detected in the depth sensor output. In some embodiments, the maximum depth parameter may be adjusted in response to the number of object features detected in the depth sensor output exceeding or falling below one or more thresholds.

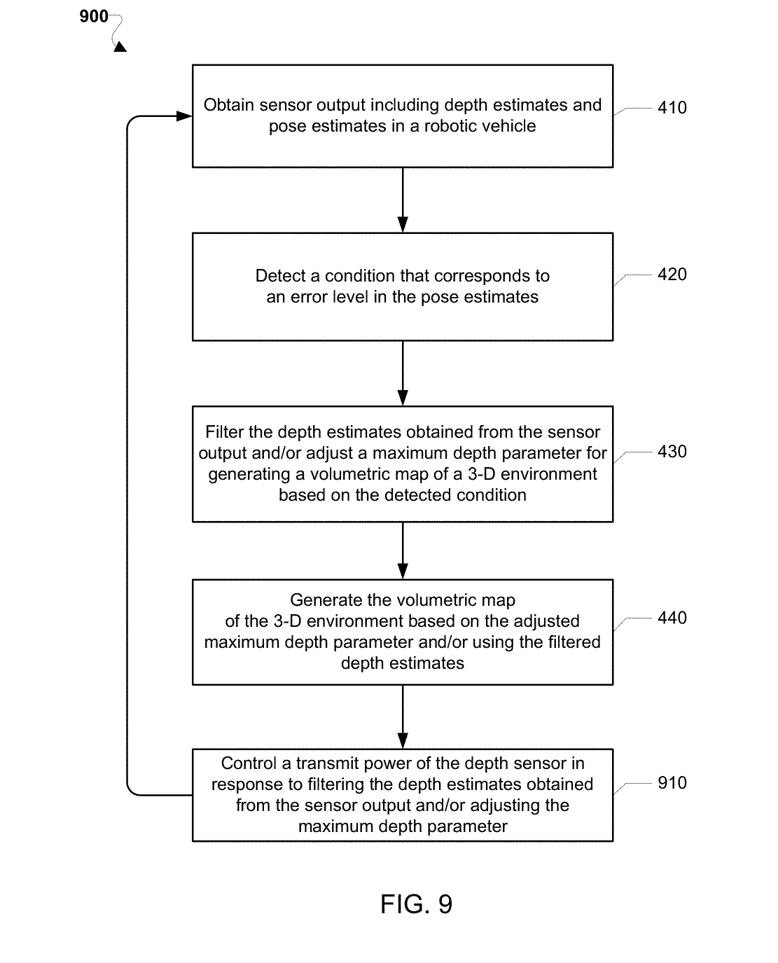

FIG. 9 illustrates a method 900 of dynamically controlling the maximum depth of a volumetric map of a 3-D environment according to some embodiments. With reference to FIGS. 1-9, operations of the method 500 may be performed by a processor (e.g., 360) of a control unit (e.g., 300) of a robotic vehicle (e.g., the UAV 200), a processor of a depth sensor (e.g., 100), or another processor (e.g., a processor dedicated to generating volumetric maps. For ease of reference, the term “processor” is used generally to refer to the processor or processors implementing operations of the method 500.

In blocks 410, 420, 430 and 440, the processor may perform operations of like numbered blocks of the method 400 as described.

In block 910, the processor may control a transmit power of the depth sensor in response to filtering the depth estimates obtained from the sensor output and/or adjusting the maximum depth parameter. In some embodiments, the depth sensor 100 may be an active sensor that probes the environment by transmitting self-generated energy and detecting energy that is reflected by objects within the sensor's field of view. Examples of such sensors may include image sensors, radar sensors, time-of-flight sensors, sonar sensors, ultrasound sensors, etc. When the depth estimates obtained from the sensor output is filtered or the maximum depth parameter is reduced as described in connection with one or more of the various embodiment methods 400, 500, 600, 700 and 800, the depth sensor may not require as much power to transmit the energy in order to detect objects within a reduced field of view that corresponds to the reduced maximum depth parameter. Thus, in some embodiments, the processor may determine a reduced amount of transmit power sufficient to enable the depth sensor to detect objects within the reduced field of view.

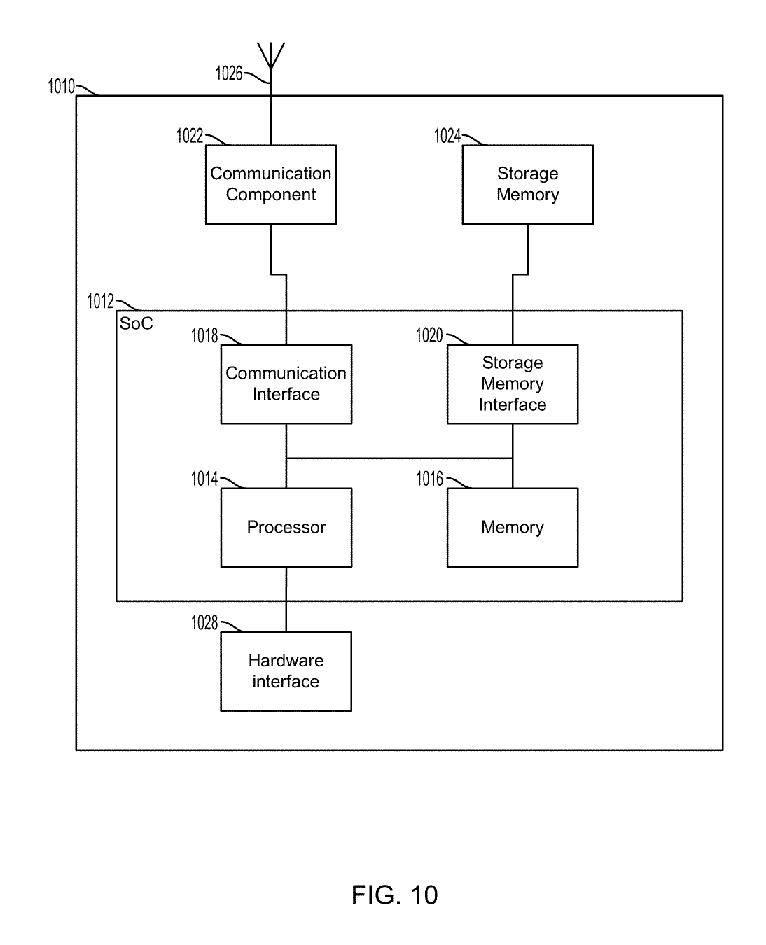

Various embodiments may be implemented within a processing device 1010 configured to be used in a robotic vehicle. A processing device may be configured as or including a system-on-chip (SoC) 1012, an example of which is illustrated FIG. 10. With reference to FIGS. 1-10, the SoC 1012 may include (but is not limited to) a processor 1014, a memory 1016, a communication interface 1018, and a storage memory interface 1020. The processing device 1010 or the SoC 1012 may further include a communication component 1022, such as a wired or wireless modem, a storage memory 1024, an antenna 1026 for establishing a wireless communication link, and/or the like. The processing device 1010 or the SoC 1012 may further include a hardware interface 1028 configured to enable the processor 1014 to communicate with and control various components of a robotic vehicle. The processor 1014 may include any of a variety of processing devices, for example any number of processor cores.

The term “system-on-chip” (SoC) is used herein to refer to a set of interconnected electronic circuits typically, but not exclusively, including one or more processors (e.g., 1014), a memory (e.g., 1016), and a communication interface (e.g., 1018). The SoC 1012 may include a variety of different types of processors 1014 and processor cores, such as a general purpose processor, a central processing unit (CPU), a digital signal processor (DSP), a graphics processing unit (GPU), an accelerated processing unit (APU), a subsystem processor of specific components of the processing device, such as an image processor for a camera subsystem or a display processor for a display, an auxiliary processor, a single-core processor, and a multicore processor. The SoC 1012 may further embody other hardware and hardware combinations, such as a field programmable gate array (FPGA), an application-specific integrated circuit (ASIC), other programmable logic device, discrete gate logic, transistor logic, performance monitoring hardware, watchdog hardware, and time references. Integrated circuits may be configured such that the components of the integrated circuit reside on a single piece of semiconductor material, such as silicon.

The SoC 1012 may include one or more processors 1014. The processing device 1010 may include more than one SoC 1012, thereby increasing the number of processors 1014 and processor cores. The processing device 1010 may also include processors 1014 that are not associated with an SoC 1012 (i.e., external to the SoC 1012). Individual processors 1014 may be multicore processors. The processors 1014 may each be configured for specific purposes that may be the same as or different from other processors 1014 of the processing device 1010 or SoC 1012. One or more of the processors 1014 and processor cores of the same or different configurations may be grouped together. A group of processors 1014 or processor cores may be referred to as a multi-processor cluster.

The memory 1016 of the SoC 1012 may be a volatile or non-volatile memory configured for storing data and processor-executable instructions for access by the processor 1014. The processing device 1010 and/or SoC 1012 may include one or more memories 1016 configured for various purposes. One or more memories 1016 may include volatile memories such as random access memory (RAM) or main memory, or cache memory.

Some or all of the components of the processing device 1010 and the SoC 1012 may be arranged differently and/or combined while still serving the functions of the various aspects. The processing device 1010 and the SoC 1012 may not be limited to one of each of the components, and multiple instances of each component may be included in various configurations of the processing device 1010.

The various embodiments illustrated and described are provided merely as examples to illustrate various features of the claims. However, features shown and described with respect to any given embodiment are not necessarily limited to the associated embodiment and may be used or combined with other embodiments that are shown and described. In particular, various embodiments are not limited to use on aerial UAVs and may be implemented on any form of robotic vehicle. Further, the claims are not intended to be limited by any one example embodiment. For example, one or more of the operations of the methods 400, 500, 600, 700, 800, and 900 may be substituted for or combined with one or more operations of the methods 400, 500, 600, 700, 800, and 900, and vice versa.

The foregoing method descriptions and the process flow diagrams are provided merely as illustrative examples and are not intended to require or imply that the steps of the various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, two or more microprocessors, one or more microprocessors in conjunction with a DSP core, or any other such configuration. Alternatively, some operations or methods may be performed by circuitry that is specific to a given function.

In one or more aspects, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module or processor-executable instructions, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A method of generating a volumetric map of a three-dimensional (3-D) environment, comprising:
obtaining sensor output including depth estimates and pose estimates in a robotic vehicle;
detecting a condition that corresponds to an error level in the pose estimates;
filtering the depth estimates obtained from the sensor output based on the detected condition; and
generating the volumetric map of the 3-D environment using the filtered depth estimates.

2. The method of claim 1, wherein filtering the depth estimates obtained from the sensor output comprises adjusting a maximum depth parameter for generating the volumetric map.

3. The method of claim 1, wherein:
detecting the condition that corresponds to the error level in the pose estimates comprises detecting a rate of rotation of the robotic vehicle; and
filtering the depth estimates obtained from the sensor output based on the detected condition comprises filtering the depth estimates obtained from the sensor output based on the detected rate of rotation.

4. The method of claim 3, wherein filtering the depth estimates obtained from the sensor output based on the detected rate of rotation comprises:
determining whether the detected rate of rotation of the robotic vehicle exceeds a threshold; and
filtering the depth estimates obtained from the sensor output to reduce a maximum depth of the volumetric map in response to determining that the detected rate of rotation of the robotic vehicle exceeds the threshold.

5. The method of claim 4, wherein filtering the depth estimates obtained from the sensor output based on the detected rate of rotation further comprises:
filtering the depth estimates obtained from the sensor output to maintain or increase the maximum depth of the volumetric map in response to determining that the detected rate of rotation of the robotic vehicle does not exceed the threshold.

6. The method of claim 1, wherein:
detecting the condition that corresponds to the error level in the pose estimates comprises detecting a noise level in the pose estimates; and
filtering the depth estimates obtained from the sensor output based on the detected condition comprises filtering the depth estimates obtained from the sensor output based on the detected noise level in the pose estimates.

7. The method of claim 1, wherein:
detecting the condition that corresponds to the error level in the pose estimates comprises detecting a number of object features in the sensor output; and
filtering the depth estimates obtained from the sensor output based on the detected condition comprises filtering the depth estimates obtained from the sensor output based on the number of object features detected in the sensor output.

8. The method of claim 1, wherein filtering the depth estimates obtained from the sensor output based on the detected condition comprises discarding depth estimates associated with depths beyond a maximum depth parameter adjusted based on the detected condition.

9. The method of claim 1, wherein filtering the depth estimates obtained from the sensor output based on the detected condition comprises assigning a reduced confidence score to depth estimates associated with depths beyond a maximum depth parameter adjusted based on the detected condition.

10. The method of claim 1, wherein filtering the depth estimates obtained from the sensor output based on the detected condition comprises generating depth estimates based on disparity data determined from the sensor output of a stereoscopic sensor, wherein the determined disparity data fall within a range of disparities selected based on the detected condition.

11. The method of claim 1, wherein filtering the depth estimates obtained from the sensor output based on the detected condition comprises generating depth estimates based on time delay data determined from the sensor output of a time-of-flight sensor, wherein the determined time delay data fall within a range of time delays selected based on the detected condition.

12. The method of claim 1, wherein filtering the depth estimates obtained from the sensor output based on the detected condition comprises limiting a number of depth levels computed in a stereoscopic depth measurement.

13. The method of claim 1, further comprising:
controlling a transmit power of a depth sensor in response to filtering the depth estimates obtained from the sensor output.

14. The method of claim 13, wherein the depth sensor is a camera, a stereoscopic camera, an image sensor, a radar sensor, a time-of-flight sensor, a sonar sensor, an ultrasound sensor, an active depth sensor, a passive depth sensor, or any combination thereof.

15. A robotic vehicle, comprising:
a depth sensor; and
a processor coupled to the depth sensor and configured with processor-executable instructions to:
obtain sensor output including depth estimates and pose estimates in the robotic vehicle;
detect a condition that corresponds to an error level in the pose estimates;
filter the depth estimates obtained from the sensor output based on the detected condition; and
generate a volumetric map of a three-dimensional (3-D) environment using the filtered depth estimates.

16. The robotic vehicle of claim 15, wherein the processor is further configured with processor-executable instructions to filter the depth estimates obtained from the sensor output by adjusting a maximum depth parameter for generating the volumetric map.

17. The robotic vehicle of claim 15, wherein the processor is further configured with processor-executable instructions to:
detect the condition that corresponds to the error level in the pose estimates by detecting a rate of rotation of the robotic vehicle; and
filter the depth estimates obtained from the sensor output based on the detected condition by filtering the depth estimates obtained from the sensor output based on the detected rate of rotation.

18. The robotic vehicle of claim 17, wherein the processor is further configured with processor-executable instructions to filter the depth estimates obtained from the sensor output based on the detected rate of rotation by:
determining whether the detected rate of rotation of the robotic vehicle exceeds a threshold; and
filtering the depth estimates obtained from the sensor output to reduce a maximum depth of the volumetric map in response to determining that the detected rate of rotation of the robotic vehicle exceeds the threshold.

19. The robotic vehicle of claim 18, wherein the processor is further configured with processor-executable instructions to filter the depth estimates obtained from the sensor output based on the detected rate of rotation by:
filtering the depth estimates obtained from the sensor output to maintain or increase the maximum depth of the volumetric map in response to determining that the detected rate of rotation of the robotic vehicle does not exceed the threshold.

20. The robotic vehicle of claim 15, wherein the processor is further configured with processor-executable instructions to:
detect the condition that corresponds to the error level in the pose estimates by detecting a noise level in the pose estimates; and
filter the depth estimates obtained from the sensor output based on the detected condition by filtering the depth estimates obtained from the sensor output based on the detected noise level in the pose estimates.

21. The robotic vehicle of claim 15, wherein the processor is further configured with processor-executable instructions to:
detect the condition that corresponds to the error level in the pose estimates by detecting a number of object features in the sensor output from the depth sensor; and
filter the depth estimates obtained from the sensor output based on the detected condition by filtering the depth estimates obtained from the sensor output based on the number of object features detected in the sensor output.

22. The robotic vehicle of claim 15, wherein the processor is further configured with processor-executable instructions to filter the depth estimates obtained from the sensor output based on the detected condition by discarding depth estimates associated with depths beyond a maximum depth parameter adjusted based on the detected condition.

23. The robotic vehicle of claim 15, wherein the processor is further configured with processor-executable instructions to filter the depth estimates obtained from the sensor output based on the detected condition by assigning a reduced confidence score to depth estimates associated with depths beyond a maximum depth parameter adjusted based on the detected condition.

24. The robotic vehicle of claim 15, wherein the processor is further configured with processor-executable instructions to filter the depth estimates obtained from the sensor output based on the detected condition by generating depth estimates based on disparity data determined from the sensor output of a stereoscopic sensor, wherein the determined disparity data fall within a range of disparities selected based on the detected condition.

25. The robotic vehicle of claim 15, wherein the processor is further configured with processor-executable instructions to filter the depth estimates obtained from the sensor output based on the detected condition by generating depth estimates based on time delay data determined from the sensor output of a time-of-flight sensor, wherein the determined time delay data fall within a range of time delays selected based on the detected condition.

26. The robotic vehicle of claim 15, wherein the processor is further configured with processor-executable instructions to filter the depth estimates obtained from the sensor output based on the detected condition by limiting a number of depth levels computed in a stereoscopic depth measurement.

27. The robotic vehicle of claim 15, wherein the processor is further configured with processor-executable instructions to control a transmit power of the depth sensor in response to filtering the depth estimates obtained from the sensor output.

28. The robotic vehicle of claim 15, wherein the depth sensor is a camera, a stereoscopic camera, an image sensor, a radar sensor, a time-of-flight sensor, a sonar sensor, an ultrasound sensor, an active depth sensor, a passive depth sensor, or any combination thereof.

29. A robotic vehicle, comprising:
a depth sensor;
means for obtaining sensor output including depth estimates and pose estimates in the robotic vehicle;
means for detecting a condition that corresponds to an error level in the pose estimates;
means for filtering depth estimates obtained from the sensor output based on the detected condition; and
means for generating a volumetric map of a three-dimensional (3-D) environment using the filtered depth estimates.

30. A processing device for use in a robotic vehicle, comprising:
a processor configured with processor-executable instructions to:
obtain sensor output including depth estimates and pose estimates in the robotic vehicle;
detect a condition that corresponds to an error level in the pose estimates;
filter the depth estimates obtained from the sensor output based on the detected condition; and
generate a volumetric map of a three-dimensional (3-D) environment using the filtered depth estimates.
